(19) United States
(12) Patent Application Publication
(10) Pub. No.: US 2024/0213671 A1
(43) Pub. Date: Jun. 27, 2024

(54) TRANSMISSION APPARATUS AND MANUFACTURING METHOD THEREOF

(71) Applicant: NEC Corporation, Tokyo (JP)

(72) Inventors: Shingo Watanabe, Tokyo (JP); Kenji Wakafuji, Tokyo (JP); Masakazu Ono, Tokyo (JP)

(73) Assignee: NEC Corporation, Tokyo (JP)

(21) Appl. No.: 18/539,720

(22) Filed: Dec. 14, 2023

(30) Foreign Application Priority Data
Dec. 21, 2022 (JP) 2022-204340

(51) Int. Cl. H01Q 3/46

(52) U.S. Cl. CPC H01Q 3/46

(57) ABSTRACT

A transmission apparatus according to one aspect of the present disclosure includes an antenna that emits a radio wave to space, a reflector that reflects a radio wave emitted from the antenna, and a reconfigurable intelligent surface (RIS) reflecting plate that reflects a radio wave from the reflector and thereby transmits the reflected radio wave to a transmission target.

### INCORPORATION BY REFERENCE

This application is based upon and claims the benefit of priority from Japanese patent application No. 2022-204340, filed on Dec. 21, 2022, the disclosure of which is incorporated herein in its entirety by reference.

### TECHNICAL FIELD

The present disclosure relates to a transmission apparatus and a manufacturing method thereof.

### BACKGROUND ART

With advancement of communication technology, various methods for transmitting and receiving a radio signal have been proposed.

For example, Japanese Unexamined Patent Application Publication No. 2022-117980 discloses the following as a technique for estimating a position of a user terminal. A reconfigurable intelligent surface (RIS) panel reflects a pilot signal transmitted from an access point according to a predetermined reflection pattern. A user terminal receiving a reflected signal extracts a feature in the signal, and estimates a position of the user terminal, based on a database including a pair of a position and one or more features.

In addition, Published Japanese Translation of PCT International Publication for Patent Application No. 2010-521915 discloses, as an in-vehicle antenna, an in-vehicle antenna including a transmitter for generating a transmission signal, a main and sub-reflector, and a waveguide associated with the transmitter for conducting the transmission signal to the sub-reflector.

### SUMMARY

Currently, beamforming of a 5th generation (5G) base station is achieved by, for example, a configuration using a solid state power amplifier (SSPA) and a phased array antenna. However, as a communication frequency is becoming high, it is supposed that more heat radiation occurs during operation due to an increase in the number of communication elements such as an antenna and an amplifier, or an increase in integration of devices.

As a solution to such a problem, a technique of providing an RIS unit being capable of directionally controlling a reflected wave, and reflecting a radio wave emitted by an antenna by the RIS unit is conceivable. This technique enables a reflected radio wave to be propagated to a target at a desired position while suppressing the above-described phenomenon of the increase in the number of elements or the increase in integration.

However, in a case where the antenna is provided in such a way as to face a front of the RIS unit, that is, a radio wave reflecting surface of the RIS unit, a part of the reflected wave from the RIS unit may hit the antenna, and propagation of the reflected wave may be hindered.

An example object to be achieved by an example embodiment of the present disclosure is to provide a transmission apparatus being capable of efficiently propagating a reflected wave from an RIS unit, and a manufacturing method of the apparatus. Note that, this object is merely one of a plurality of objects to be achieved by a plurality of the example embodiments disclosed herein. Other objects, or problems and novel features will be apparent from the description or the accompanying drawings of the present description.

In a first example aspect of the present disclosure, a transmission apparatus includes: an antenna configured to emit a radio wave to space; a reflector configured to reflect a radio wave emitted from the antenna; and a reconfigurable intelligent surface (RIS) reflecting plate configured to reflect a radio wave from the reflector and thereby transmit the reflected radio wave to a transmission target.

In a second example aspect of the present disclosure, a manufacturing method of a transmitter is a method of manufacturing a transmission apparatus by providing an antenna configured to emit a radio wave to space, providing a reflector configured to reflect a radio wave emitted from the antenna, and providing a reconfigurable intelligent surface (RIS) reflecting plate configured to reflect a radio wave from the reflector and thereby transmit the reflected radio wave to a transmission target.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a schematic diagram of a transmission apparatus according to the present disclosure;

FIG. 2 is a schematic diagram of the transmission apparatus according to the present disclosure;

FIG. 3 is a diagram illustrating an appearance of an RIS reflecting plate according to the present disclosure;

FIG. 4 is a schematic diagram of a transmission apparatus according to a related art;

FIG. 5 is a schematic diagram of a transmission apparatus according to another related art;

FIG. 6A is a schematic diagram illustrating an incident wave on the RIS reflecting plate when a radio wave transmission source is located far when viewed from the RIS reflecting plate;

FIG. 6B is a schematic diagram illustrating a reflected wave from the RIS reflecting plate;

FIG. 6C is a schematic diagram illustrating an incident wave on the RIS reflecting plate when the radio wave transmission source is at a short distance when viewed from the RIS reflecting plate;

FIG. 7 is a schematic diagram of the transmission apparatus according to the present disclosure;

FIG. 8 is a schematic diagram for describing a path difference in reflection from an RIS curved surface unit; and

FIG. 9 is a block diagram illustrating one example of a hardware configuration of a control apparatus according to the present disclosure.

### EXAMPLE EMBODIMENT

Hereinafter, example embodiments of the present disclosure will be described with reference to the drawings. Note that, the following description and the drawings in the example embodiments are omitted and simplified as appropriate for clarity of description. In addition, in this disclosure, unless otherwise specified, when, for a plurality of items, “at least one of them” is defined, the definition may mean any one item, or may mean any plurality of items (including all items).

Each drawing referenced in the example embodiments is merely an example in order to describe one or more example embodiments. Each drawing may be associated with one or more other example embodiments, rather than only one particular example embodiment. As those skilled in the art will appreciate, various features or steps described with reference to any one of the drawings may be combined with features or steps illustrated in one or more other drawings, for example, in order to create an example embodiment not explicitly illustrated or described. All of the features or steps illustrated in any one of the drawings in order to describe the exemplary example embodiments are not necessarily essential, and some features or steps may be omitted. An order of the steps described in any of the drawings may be changed as appropriate.

### First Example Embodiment

### [Description of Configuration]

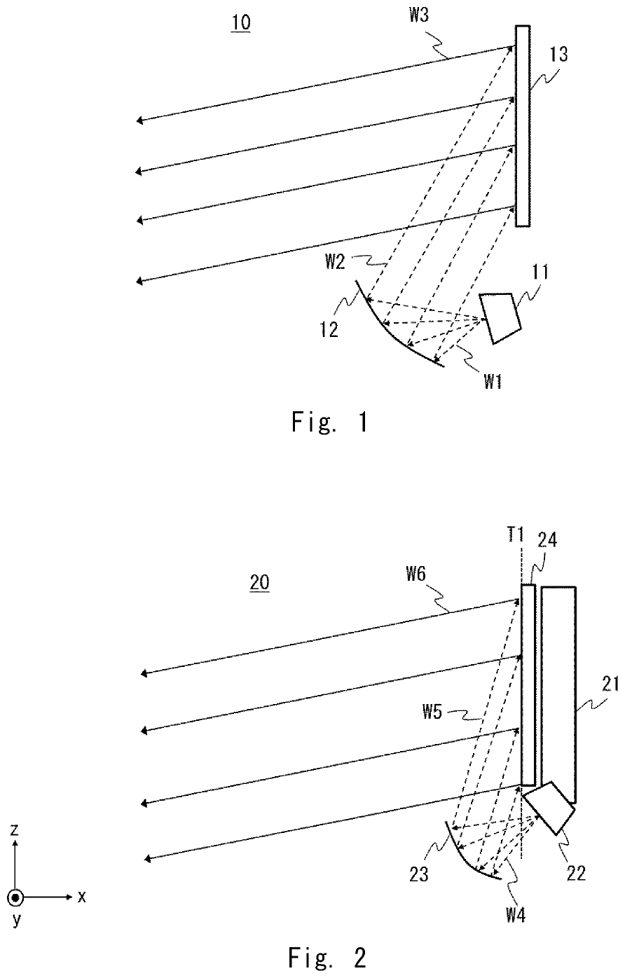

FIG. 1 is a schematic diagram of a transmission apparatus. A transmission apparatus 10 capable of transmitting a radio wave signal includes an emission unit 11, a reflection unit 12, and a reconfigurable intelligent surface (RIS) unit 13. The transmission apparatus 10 is an apparatus that can be mounted on any radio facility, and constitutes, for example, a base station. Hereinafter, each unit of the transmission apparatus 10 will be described.

The emission unit 11 emits a radio wave W1 in space, and has at least any kind of antenna as a hardware configuration. The radio wave W1 can be any signal. Note that, in a preceding stage of the antenna of the emission unit 11, an amplifier for amplifying a signal transmitted by the radio wave W1 may be provided, or a waveguide for transmitting a radio wave signal to the antenna may be provided. The radio wave W1 emitted from the emission unit 11 reaches the reflection unit 12.

The reflection unit 12 reflects the radio wave W1 emitted from the emission unit 11, and has at least a reflector as a hardware configuration. A surface shape of the reflector has any shape for reflecting the radio wave W1 from the emission unit 11 and causing a reflected radio wave W2 to reach the RIS unit 13. A surface on which radio wave reflection is performed in the reflector may be formed as a curved surface such as a paraboloid or a flat surface, but the surface shape is not limited thereto.

The RIS unit 13 reflects the radio wave W2 from the reflection unit 12, and thereby transmits a reflected radio wave W3 to a predetermined transmission target. The transmission target is an apparatus capable of receiving the radio wave W3. For example, when the transmission apparatus 10 constitutes a node of a communication network, the transmission target may be another node in the network.

Note that, the RIS unit 13 includes, for example, a reflecting plate using a smart surface technique or a meta surface technique. The reflecting plate can dynamically change a reflection characteristic of an incident wave at a surface of the plate. For example, when a plurality of reflecting elements are provided on the reflecting plate, each of the reflecting elements can change a reflection direction of an incident wave to any direction by adjusting a reflection phase of the incident wave on each of the reflecting elements. As a result, the RIS unit 13 can perform at least one of focusing and propagating the radio wave W3 to a specific spot, or changing a direction of propagating the radio wave W3.

Note that, a control apparatus including a central processing unit (CPU) and the like may be connected to the RIS unit 13 in order to control the reflecting element. Details of the control apparatus will be described later.

Note that, a positional relationship among the emission unit 11, the reflection unit 12, and the RIS unit 13 can be any positional relationship as long as the radio wave W1 from the emission unit 11 is reflected by the reflection unit 12 and the reflected radio wave W2 is reflected by the RIS unit 13. In addition, the transmission apparatus 10 can be manufactured by providing the emission unit 11, the reflection unit 12, and the RIS unit 13 in such a way as to satisfy such a positional relationship.

### [Description of Advantageous Effect]

As described above, in the transmission apparatus 10, the reflection unit 12 is provided in a radio wave path between the emission unit 11 and the RIS unit 13. In other words, the emission unit 11 does not need to directly emit a radio wave to the RIS unit 13. Thus, since it is not necessary to provide the emission unit 11 on a front of the RIS unit 13, that is, at a position opposite to a radio wave reflecting surface of the RIS unit 13, it is possible to suppress a phenomenon in which propagation of the radio wave W3 reflected from the RIS unit 13 is hindered by the emission unit 11. Therefore, the transmission apparatus 10 can efficiently propagate a reflected wave from the RIS unit 13.

### Second Example Embodiment

Hereinafter, a second example embodiment of the present disclosure will be described with reference to the drawings. The second example embodiment discloses a specific example of a transmission apparatus described in the first example embodiment. The description of the matters already described in the first example embodiment will be omitted as appropriate in the following description. Note that, a specific example of the transmission apparatus described in the second example embodiment is not limited to the one described below. In addition, the configuration and processing described below are merely examples, and are not limited thereto.

### [Description of Configuration]

FIG. 2 is a schematic diagram of the transmission apparatus. A transmission apparatus 20 is an apparatus provided in a base station of a mobile communication system of 5G or later. The transmission apparatus 20 includes a traveling wave tube amplifier (TWTA) 21, an antenna 22, a reflector 23, and an RIS reflecting plate 24. The antenna 22 corresponds to the emission unit 11, the reflector 23 corresponds to the reflection unit 12, and the RIS reflecting plate 24 corresponds to the RIS unit 13. Hereinafter, each unit of the transmission apparatus 20 will be described.

The TWTA 21 has an electron tube inside, and is a high-power amplifier that amplifies energy of an electromagnetic wave by causing an electron beam and the electromagnetic wave to interact with each other in the electron tube. An output of the amplified electromagnetic wave is, for example, about several hundred watts.

When beamforming of a radio wave signal is performed by using such a TWTA 21, switching an orientation direction of the radio wave signal is performed by direction control of an antenna by a machine. However, when the TWTA 21 is used in performing mobile communication on a ground wave, there is a possibility that a direction of the antenna cannot be sufficiently followed with respect to a moving terminal by such a direction control method. Thus, in this example, beamforming is performed by using the RIS reflecting plate 24.

As one example, the TWTA 21 is compatible with a 28 GHz band, but a frequency of a radio wave output from the TWTA 21 is not limited thereto. In addition, the TWTA 21 has a substantially rectangular parallelepiped shape, and, in FIG. 2, has dimensions of about 7 cm, 7 cm, and 40 cm in an x-axis direction, a y-axis direction, and a z-axis direction, respectively, but the dimensions of the TWTA 21 are not limited thereto. In addition, an amplifier connected to the antenna 22 is not limited to the TWTA 21, and may be another type of high-power amplifier such as a solid state power amplifier (SSPA). However, in a case where a so-called “millimeter wave band” radio wave, which is a frequency in a range of 30 GHz to 300 GHz and a frequency in a vicinity thereof, is used for communication, it is more preferable to use the TWTA because the TWTA has a higher output and higher efficiency than the SSPA.

The antenna 22 is connected to the TWTA 21, and emits an electromagnetic wave output from the TWTA 21 as a radio wave W4. The radio wave W4 can be any signal to be transmitted to a terminal. The radio wave W4 emitted from the antenna 22 reaches the reflector 23. In FIG. 2, a direction in which the radio wave W4 travels is a negative direction in the x-axis direction.

The antenna 22 is a horn antenna in this example, and is formed in such a way that an opening area of an open end of the antenna is to be widen along a direction to which a radio wave is emitted. In addition, the antenna 22 is provided at any position with respect to the reflector 23 and the RIS reflecting plate 24 under a condition that the radio wave W4 reaches the reflector 23 and also a radio wave W5 reflected by the reflector 23 reaches the RIS reflecting plate 24.

The antenna 22 is provided, together with the TWTA 21, on a back side of a reflecting surface on which the RIS reflecting plate 24 reflects the radio wave W5 when viewed from a direction in which the radio wave W5 is incident on the RIS reflecting plate 24 from the reflector 23. In other words, it can be said that the TWTA 21 and the antenna 22 are provided on a back side of the RIS reflecting plate 24. Herein, in the RIS reflecting plate 24, a radio wave reflecting surface side is defined as a front, and an opposite side thereof is defined as a back. In FIG. 2, the TWTA 21 and the antenna 22 are located in a positive direction in the x-axis direction than a tangent line Tl on the reflecting surface of the RIS reflecting plate 24.

In addition, in this example, the TWTA 21 is provided on the back side of the RIS reflecting plate 24 in such a way that a longest side of the TWTA 21 becomes parallel to a tangent line of the back of the RIS reflecting plate 24. The longest side is a side of the TWTA 21 having 40 cm. More specifically, the longest side of the TWTA 21 is provided in such a way as to be in contact with the back of the RIS reflecting plate 24.

The reflector 23 reflects the radio wave W4 emitted from the antenna 22, and causes the reflected radio wave W5 to reach the RIS reflecting plate 24. In FIG. 2, a direction in which the radio wave W5 travels is a positive direction in the x-axis direction. A surface on which radio wave reflection is performed in the reflector 23 is a parabolic-type (i.e., parabolic) herein. In addition, a size of the reflector 23 is smaller as compared with that of the RIS reflecting plate 24.

The radio wave W5 from the reflector 23 is obliquely incident on the RIS reflecting plate 24 with respect to a normal line on the reflecting surface of the plate. The RIS reflecting plate 24 reflects the radio wave W5, and thereby transmits a reflected radio wave W6 to a terminal being a transmission target. In FIG. 2, a direction in which the radio wave W5 travels is a negative direction in the x-axis direction. The RIS reflecting plate 24 can perform at least one of focusing and propagating the radio wave W5 to a specific spot, or changing a direction of propagating the radio wave W5.

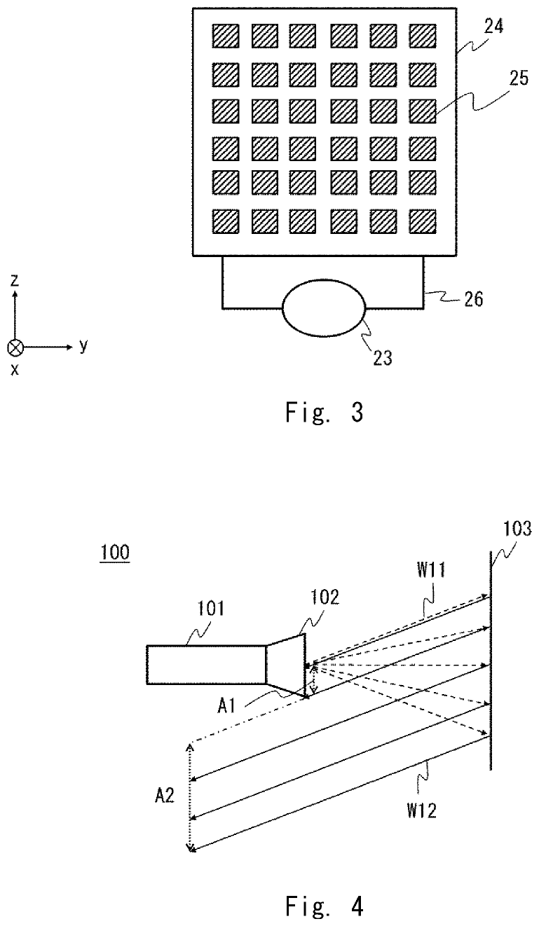

FIG. 3 is a diagram illustrating an appearance of the RIS reflecting plate 24 in FIG. 2. The RIS reflecting plate 24 has a radio wave reflecting surface being a flat surface having a substantially square shape in the y-axis direction and the z-axis direction, and forms a plurality of reflecting elements 25 on the radio wave reflecting surface. The plurality of reflecting elements 25 are provided in such a way that a distance between adjacent reflecting elements 25 is substantially constant in a longitudinal direction and a lateral direction of the substantially square radio wave reflecting surface. Each of the reflecting elements 25 can adjust a reflection phase of a radio wave being incident on the reflecting element 25, and thereby can control a reflection direction, i.e., directivity, of the radio wave. In addition, a control apparatus (not illustrated) for controlling the reflecting element 25 is connected to the RIS reflecting plate 24.

As one example, the RIS reflecting plate 24 may be a square having a size of about 30 to 50 cm on one side thereof, but the size of the RIS reflecting plate 24 is not limited thereto. In addition, a shape of the radio wave reflecting surface of the RIS reflecting plate 24 is not limited to a square, and may be a rectangle or the like. Further, the radio wave reflecting surface of the RIS reflecting plate 24 is not limited to a flat surface, and may be a curved surface. A specific example of a case where the radio wave reflecting surface of the RIS reflecting plate 24 is a curved surface will be described in a third example embodiment.

In addition, the RIS reflecting plate 24 is connected to the reflector 23 by a connecting portion 26, and thereby a positional relationship between the RIS reflecting plate 24 and the reflector 23 is fixed. As illustrated in FIG. 2, the RIS reflecting plate 24 and the reflector 23 are separated from each other by a predetermined distance in the x-axis direction. As one example, a separation distance may be a short distance of, for example, about 20 to 30 cm, but the separation distance is not limited thereto. However, an installation position of the reflector 23 can be adjusted by the connecting portion 26 in such a way that the reflector 23 does not hinder a path of the radio wave W6 being a reflected wave from the RIS reflecting plate 24, and the radio wave W5 being a reflected wave from the reflector 23 is irradiated to the entire surface of the reflecting surface of the RIS reflecting plate 24. In addition, a shape of the reflector 23 can be changed as appropriate.

In this example, the RIS reflecting plate 24 is mounted as one member of the transmission apparatus 20 constituting the base station. The RIS reflecting plate 24 is utilized as a phased array antenna that reflects a radio wave signal amplified by the TWTA 21 while directionally controlling the signal.

### [Description of Advantageous Effect]

As described above, in the transmission apparatus 20, since the reflector 23 is provided in a radio wave path between the antenna 22 and the RIS reflecting plate 24, it is not necessary to provide the antenna 22 at a position facing the radio wave reflecting surface of the RIS reflecting plate 24. Thus, it is possible to suppress a phenomenon in which propagation of the radio wave W6 reflected from the RIS reflecting plate 24 is hindered by the antenna 22. Therefore, the transmission apparatus 20 can efficiently propagate a reflected wave.

FIG. 4 is a schematic diagram of a transmission apparatus 100 according to a related art. In FIG. 4, the transmission apparatus 100 includes a TWTA 101, an antenna 102, and an RIS reflecting plate 103. The TWTA 101 outputs an amplified radio wave signal to the antenna 102, and the antenna 102 being a horn antenna emits the radio wave signal as a radio wave W11. The RIS reflecting plate 103 reflects the radio wave W11 from the antenna 102, and thereby transmits a reflected radio wave W12 to a terminal being a transmission target.

The TWTA 101 and the antenna 102 are provided at positions opposed to a central portion of a reflecting surface of the RIS reflecting plate 103, and an open end of the antenna 102 faces a front of the reflecting surface of the RIS reflecting plate 103. At this time, as illustrated in FIG. 4, since a part of the radio wave W12 reflected by the RIS reflecting plate 103 hits the antenna 102 in a region A1, a part of the radio wave W12 is not transmitted to the terminal. In this example, only the radio wave W12 passing through a region A2 is transmitted to the terminal. Thus, propagation of a reflected wave from the RIS reflecting plate 103 is hindered. In addition, a size of the transmission apparatus 100 in a front direction of the RIS reflecting plate 103 increases.

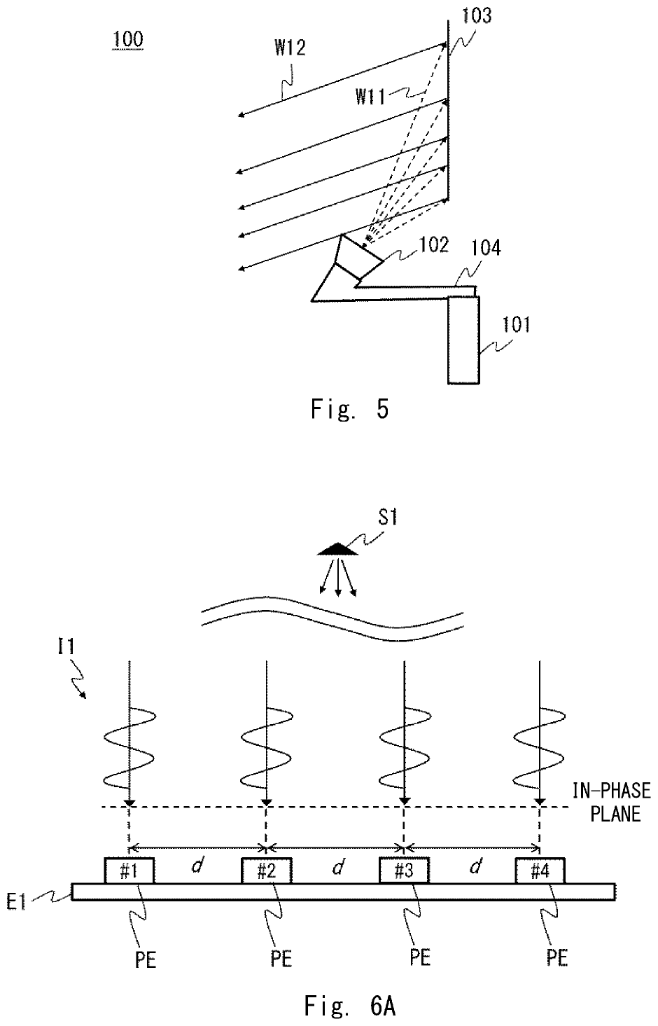

FIG. 5 is a schematic diagram of a transmission apparatus according to another related art. In FIG. 5, a transmission apparatus 100 includes a TWTA 101, an antenna 102, an RIS reflecting plate 103, and a waveguide 104. The transmission apparatus in FIG. 5 is different from the transmission apparatus in FIG. 4 in that the waveguide 104 is newly provided between the TWTA 101 and the antenna 102, and a radio wave signal from the TWTA 101 is emitted from the antenna 102 via the waveguide 104.

By providing the waveguide 104, the antenna 102 can be provided at a position deviated from a position opposed to a center portion of a reflecting surface of the RIS reflecting plate 103. In addition, an open end of the antenna 102 can be provided in such a way as to face the reflecting surface of the RIS reflecting plate 103 in an angled state rather than in front. By adjusting a position and a direction of the antenna 102 in this manner, the antenna 102 can be installed at a position where propagation of a reflected wave from the RIS reflecting plate 103 is not hindered. However, since a waveguide is usually expensive, it is considered that a new problem arises that a cost of the transmission apparatus 100 increases.

In contrast, in the transmission apparatus 20, since the reflector 23 is provided in a radio wave path between the antenna 22 and the RIS reflecting plate 24, it is not necessary to provide the antenna 22 at a position opposite to the radio wave reflecting surface of the RIS reflecting plate 24. Thus, it is possible to suppress a phenomenon in which the propagation of a reflected wave from the RIS reflecting plate 24 is hindered. In addition, since it is not necessary to provide a waveguide between the antenna 22 and the reflector 23, and between the reflector 23 and the RIS reflecting plate 24, a cost of the transmission apparatus 20 can be suppressed.

In addition, by providing the antenna 22 on the back side of the RIS reflecting plate 24, it is possible to suppress a dimension of the transmission apparatus 20 in a front direction of the RIS reflecting plate 24. Further, also by providing the TWTA 21 on the back side of the RIS reflecting plate 24, it is possible to suppress a dimension of the transmission apparatus 20 in the x-axis direction in FIG. 2. In particular, when the TWTA 21 is disposed in such a way that the longest side of the TWTA 21 becomes parallel to the reflecting surface of the RIS reflecting plate 24, an effect of suppressing the dimension of the transmission apparatus 20 in the x-axis direction is increased. With such a disposition method, an advantageous effect that a size of the entire transmission apparatus 20 can be suppressed and the transmission apparatus 20 can be easily attached is acquired.

In addition, in the reflector 23, a reflecting surface that reflects a radio wave may form a paraboloid. As a result, since a radio wave emitted from the antenna 22 can be efficiently propagated to the RIS reflecting plate 24, communication efficiency can be improved.

### Third Example Embodiment

Hereinafter, a third example embodiment of the present disclosure will be described with reference to the drawings. The third example embodiment discloses a further specific example of a transmission apparatus described in the first example embodiment. Note that, descriptions of the points already described in the second example embodiment will be omitted as appropriate.

In the second example embodiment, the reflector 23 constitutes a parabolic surface, and the RIS reflecting plate 24 constitutes a flat surface. Herein, since a distance between the reflector 23 and the RIS reflecting plate 24 is a short distance, and also the reflector 23 is smaller as compared with the RIS reflecting plate 24, a radio wave being incident on the RIS reflecting plate 24 does not become a plane wave. Therefore, in order to make a reflected wave from the RIS reflecting plate 24 a plane wave, it is necessary to change a phase applied to an incident wave in the RIS reflecting plate 24 for each reflecting element. Hereinafter, this point will be described in detail.

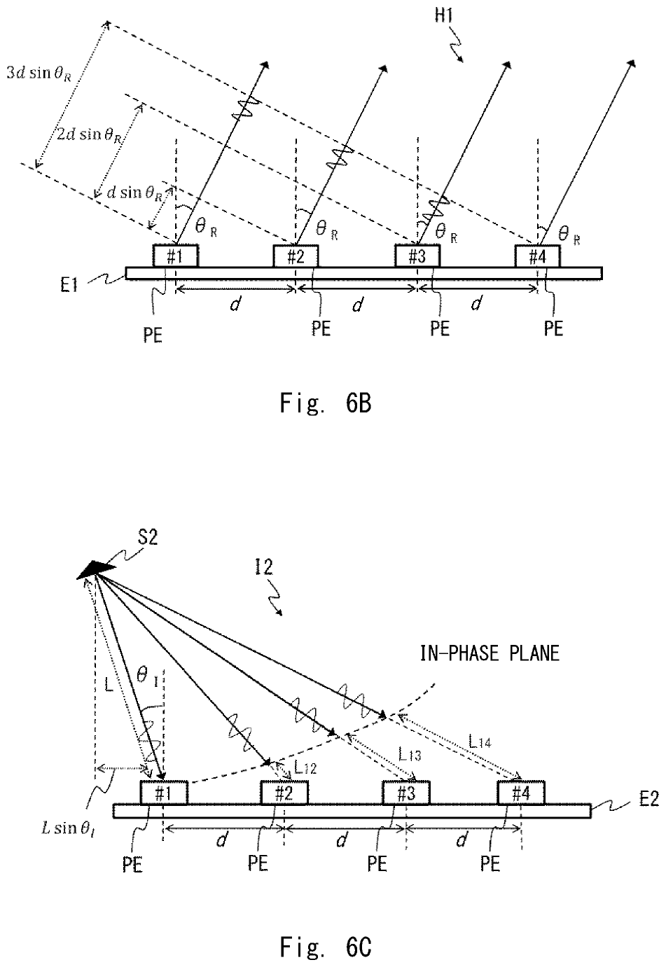

FIG. 6A is a schematic diagram illustrating an incident wave on an RIS reflecting plate when a radio wave transmission source is sufficiently located far when viewed from the RIS reflecting plate. In FIG. 6A, a radio wave transmission source S1 may be separated from an RIS reflecting plate E1 by several tens of meters or more. In addition, the radio wave transmission source S1 causes a radio wave I1 to be incident from a front of the RIS reflecting plate E1. In other words, an incident angle of the radio wave I1 emitted to the RIS reflecting plate E1 is substantially 0°. In this case, the radio wave I1 being incident on the RIS reflecting plate E1 can be regarded as a plane wave.

The RIS reflecting plate E1 is provided with reflecting elements PE #1 to PE #4 that perform directional control of a reflected wave. At this time, the radio waves I1 incident on each of the reflecting elements PE #1 to PE #4 are all in phase. Note that, the reflecting elements PE #1 to PE #4 are separated from each other by a distance d with respect to the adjacent reflecting element.

FIG. 6B is a schematic diagram illustrating a reflected wave from an RIS reflecting plate. In other words, FIG. 6B illustrates a state in which time has elapsed since a state illustrated in FIG. 6A and the radio wave I1 has been reflected. A radio wave H1 reflected from a certain reflecting element and a radio wave H1 reflected from a reflecting element adjacent to the certain reflecting element differ in path difference by dsinθ_{R} in a surface perpendicular to the radio wave H1. Herein, OR is a reflection angle of the radio wave H1. When a wavelength of a radio wave is assumed to λ, a phase difference Δφ_{θR} occurred by the path difference dsinθ_{R} is represented by the following equation.

$$\begin{matrix}[ Mathematical 1 ] & \\ {Δ∅}_{{θ}_{R}} = \frac{2 π}{λ} d sin {θ}_{R} & ( 1 )\end{matrix}$$

Therefore, when a phase control amount μ_{#1} in the reflecting element PE #1 is assumed to 0, phase control amounts φ_{#2} to φ_{#4} in the reflecting elements PE #2 to PE #4 are respectively assumed as follows:

$${φ}_{\#2} = - {Δφ}_{θ R} \qquad ( 2 )$$

$${φ}_{\#3} = - 2 {Δφ}_{θ R} \qquad ( 3 )$$

$${φ}_{\#4} = - 3 {Δφ}_{θ R} \qquad ( 4 )$$

then, the radio wave H1 can become a plane wave. In other words, the radio wave H1 is highly directional in a OR direction. A control apparatus that controls each of the reflecting elements can calculate the phase control amounts indicated in (2) to (4) by acquiring information of the wavelength A, the reflection angle θ_{R}, and the distance d. Since the control apparatus controls each of the reflecting elements by using the phase control amount calculated in this way, the radio wave H1 can become a plane wave.

FIG. 6C is a schematic diagram illustrating an incident wave on an RIS reflecting plate when a radio wave transmission source is at a short distance when viewed from the RIS reflecting plate. In FIG. 6C, a radio wave transmission source S2 is separated from an RIS reflecting plate E2 by several tens of centimeters. In addition, the radio wave transmission source S2 causes a radio wave having an incident angle not being 0° with respect to a normal line of the RIS reflecting plate E2 to be incident on the RIS reflecting plate E2 as a radio wave I2. In other words, a radio wave from the radio wave transmission source S2 is obliquely incident on the RIS reflecting plate E2. Note that, the radio wave transmission source S2 corresponds to the reflector 23, and the RIS reflecting plate E2 corresponds to the RIS reflecting plate 24.

As illustrated in FIG. 6C, a distance from the radio wave transmission source S2 to each of the reflecting elements PE #1 to PE #4 is not the same distance but different distances from each other. For example, it is assumed that a distance from the radio wave transmission source S2 to the reflecting element PE #1 is L, and an incident angle of the radio wave I2 being incident on the reflecting element PE #1 is θ₁. The reflecting elements PE #1 to PE #4 are separated from each other by a distance d with respect to the adjacent reflecting element. In addition, it is assumed that a difference between a distance from the radio wave transmission source S2 to the reflecting element PE #2 and the distance from the radio wave transmission source S2 to the reflecting element PE #1 is an L₁₂, a difference between a distance from the radio wave transmission source S2 to the reflecting element PE #3 and the distance from the radio wave transmission source S2 to the reflection element PE #1 is an L₁₃, and a difference between a distance from the radio wave transmission source S2 to the reflecting element PE #4 and the distance from the radio wave transmission source S2 to the reflection element PE #1 is an L₁₄. At this time, the L₁₂, the L₁₃, and the L₁₄ are represented as follows.

$$[ Mathematical 2 ]$$

$${L}_{12} = \sqrt{{( L cos {θ}_{I} )}^{2} + {( d + L sin {θ}_{I} )}^{2}} - L \qquad ( 5 )$$

$$[ Mathematical 3 ]$$

$${L}_{13} = \sqrt{{( L cos {θ}_{I} )}^{2} + {( 2 d + L sin {θ}_{I} )}^{2}} - L \qquad ( 6 )$$

$$[ Mathematical 4 ]$$

$${L}_{14} = \sqrt{{( L cos {θ}_{I} )}^{2} + {( 3 d + L sin {θ}_{I} )}^{2}} - L \qquad ( 7 )$$

As described above, a different path difference occurs in a radio wave being incident on the RIS reflecting plate E2 for each reflecting element. Thus, the radio wave 12 does not become in phase in each of the reflecting elements. In other words, unlike the radio wave I1 in FIG. 6A, the radio wave 12 cannot be regarded as a plane wave.

A schematic diagram of a state in which time has elapsed since a state illustrated in FIG. 6C and the radio wave 12 has been reflected by an RIS reflecting plate is as illustrated in FIG. 6B. However, as described above, the radio wave 12 being incident on the RIS reflecting plate E2 cannot be regarded as a plane wave. Thus, when the phase control amount φ_{#1} in the reflecting element PE #1 is assumed to 0, in order to make the radio wave H1 reflected by the RIS reflecting plate E2 a plane wave, the phase control amounts φ_{#2} to φ_{#4} in each reflecting elements PE #2 to PE #4 need to be set as follows.

$$[ Mathematical 5 ]$$

$${∅}_{\#2} = + \frac{2 π}{λ} {L}_{12} - {Δ∅}_{θ R} \qquad ( 8 )$$

$$[ Mathematical 6 ]$$

$${∅}_{\#3} = + \frac{2 π}{λ} {L}_{13} - 2 {Δ∅}_{θ R} \qquad ( 9 )$$

$$[ Mathematical 7 ]$$

$${∅}_{\#4} = + \frac{2 π}{λ} {L}_{14} - 3 {Δ∅}_{θ R} \qquad ( 10 )$$

Unlike the phase control amounts φ_{#2} to φ_{#4} indicated in (2) to (4) described above, the phase control amounts φ_{#2} to φ_{#4} indicated in (8) to (10) further include a term for correcting the phase difference derived from the path differences L₁₂, L₁₃, and L₁₄ at the incidence. Therefore, the control apparatus of the RIS reflecting plate E2 needs to acquire not only information on the wavelength λ, the reflection angle θ_{R}, and the distance d but also information on the distance L and the incident angle θ₁ in order to make the radio wave H1 reflected by the RIS reflecting plate E2 a plane wave. In addition, calculation of the phase control amount in each of the reflecting elements is also complicated.

In the third example embodiment, a transmission apparatus that improves on the above-described points is indicated.

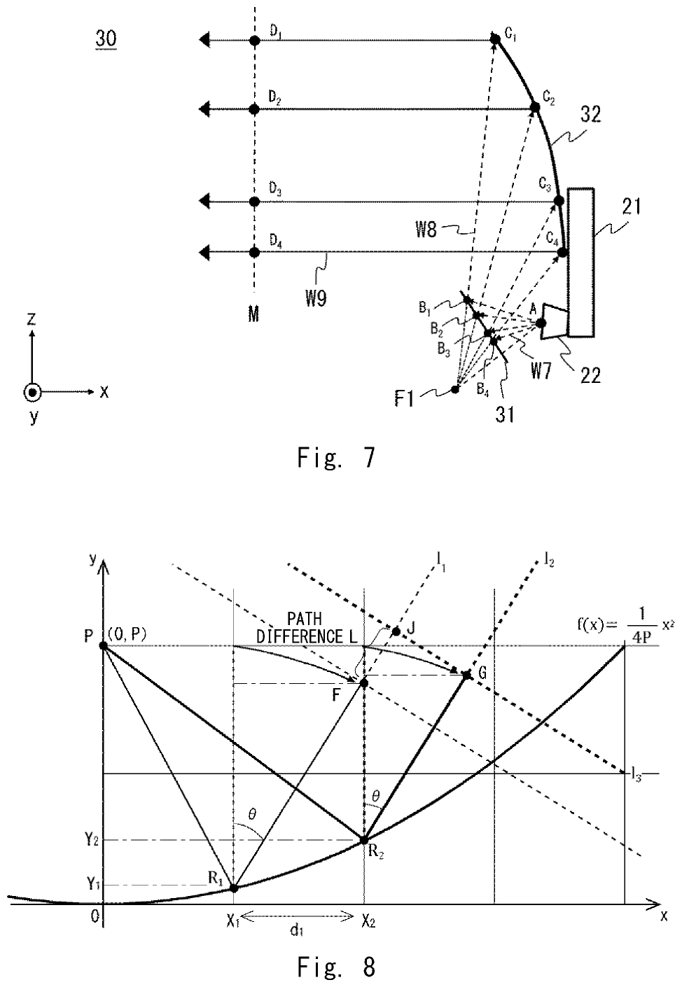

FIG. 7 is a schematic diagram of a transmission apparatus. A transmission apparatus 30 is an apparatus provided in a base station of a mobile communication system of 5G or later, and includes a TWTA 21, an antenna 22, a reflector 31, and an RIS curved surface unit 32.

The description of the TWTA 21 and the antenna 22 is similar to that of the second example embodiment, and thus the description thereof is omitted. A radio wave W7 emitted from the antenna 22 reaches the reflector 31.

The reflector 31 reflects the radio wave W7 emitted from the antenna 22, and causes a reflected radio wave W8 to reach the RIS curved surface unit 32. In FIG. 7, a direction in which the radio wave W8 travels is a positive direction in an x-axis direction. A surface on which radio wave reflection is performed in the reflector 31 is a flat surface herein, and this point is different from that in the second example embodiment in which the surface on which the radio wave reflection is performed is a curved surface.

The RIS curved surface unit 32 reflects the radio wave W8 from the reflector 31, and thereby transmits a reflected radio wave W9 to a terminal being a transmission target. In FIG. 7, a direction in which the radio wave W9 travels is a negative direction in the x-axis direction. Similarly to the RIS reflecting plate 24, the RIS curved surface unit 32 can control directivity of the radio wave W9. However, the RIS curved surface unit 32, unlike the RIS reflecting plate 24, a radio wave reflecting surface is configured to be a parabolic-type (i.e., parabolic) rather than a flat surface.

A positional relationship among the antenna 22, the reflector 31, and the RIS curved surface unit 32 will be described in more detail. In FIG. 7, an emission point A being a point where a radio wave is emitted from the antenna 22 is located at a position where a flat surface constituted by the reflector 31 is plane-symmetric with a focal point F1 of a parabola constituted by the RIS curved surface unit 32. As a result, a radio wave emitted from the emission point A moves by the same distance from the emission point A when the radio wave reaches a plane M perpendicular to a traveling direction of the radio wave W9 through any path.

In FIG. 7, it is illustrated that the radio waves W7 emitted from the emission point A are reflected at points B₁ to B₄ on the reflector 31, the radio waves W8 reflected at each of the points B₁ to B₄ are reflected at points C₁ to C₄ on the RIS curved surface unit 32, and thereafter the radio waves W9 reflected at each points C₁ to C₄ reach each of the points D₁ to D₄ of the plane M. At this time, when it is assumed that each of distances from the emission point A to the point D₁, from the emission point A to the point D₂, from the emission point A to the point D₃, and from the emission point A to the point D₄ are AB₁C₁D₁, AB₂C₂D₂, AB₃C₃D₃, and AB₄C₄D₄, values of AB₁C₁D₁, AB₂C₂D₂, AB₃C₃D₃, and AB₄C₄D₄ become all the same. Therefore, when the phase control amounts of each of the reflecting elements on the points C₁ to C₄ on the RIS curved surface unit 32 are the same, and a reflection direction of an incident wave is not changed in each of the reflecting elements, the radio wave W9 being reflected from the RIS curved surface unit 32 and traveling in the negative direction in the x-axis direction becomes a plane wave. At this time, the plane M is an equiphase plane. A case where the phase control amounts of each of the reflecting elements on the points C₁ to C₄ on the RIS curved surface unit 32 are the same includes, for example, a case where phase control is not performed in each of the reflecting elements, and a case where the control is performed in such a way that the same phase is applied to a radio wave inputted in each of the reflecting elements.

In addition, hereinafter, an example in which the reflection direction of an incident wave is controlled in each of the reflecting elements and a radio wave propagates in a direction different from the radio wave W9 illustrated in FIG. 7 will also be described.

FIG. 8 is a schematic diagram for describing a path difference in reflection from the RIS curved surface unit 32 when a radio wave is emitted to the RIS curved surface unit 32 being the paraboloid illustrated in FIG. 7. In FIG. 8, the RIS curved surface unit 32 forms the parabola indicated below on an xy-plane.

$$[ Mathematical 8 ]$$

$$f ( x ) = \frac{1}{4 P} {x}^{2} \qquad ( 11 )$$

A point P located at (0, P) in an xy coordinate is a focal point, and corresponds to the focal point F1 in FIG. 7.

In addition, reflecting elements R₁ and R₂ are provided at points R₁ and R₂ on the RIS curved surface unit 32, respectively, and a coordinate of each of the points R₁ and R₂ is (X₁, Y₁) and (X₂, Y₂), respectively. Herein, the Y₁ is X₁²/4P, and the Y₂ is X₂²/4P. In addition, the X₂ is separated from the X₁ by d₁. Then, each of the reflecting elements at the points R₁ and R₂ reflect radio waves incident from the focal point P by the reflection angle θ not being 0°.

In this state, radio waves reflected from the points R₁ and R₂ in a θ direction are represented as lines l₁ and l₂, respectively. Then, it is assumed that the PR₁F=PR₂G is acquired, when a point F located on the line l₁ and a point G located on the line l₂ are set, and a distance from the focal point P to the point F via the point R₁ is set as the PR₁F, and a distance from the focal point P to the point G via the point R₂ is set as the PR₂G. Herein, when it is assumed that a line l₃ that passes through the point G and is perpendicular to the lines l₁ and l₂, and an intersection point of the line l₃ and the line l₁ is a point J, as illustrated in FIG. 8, the point J and the point G are separated by the path difference L. Since a phase difference L·2π/λ due to the path difference L is occurred at the point J and the point G, in order to make a plane corresponding to the line I₃ in three dimensions an equiphase plane, the phase control needs to be performed by the reflecting element.

For example, when the reflecting element R₁ is used as a reference element, the reflecting element R₂ performs phase control for correcting the path difference L, thereby the phases of the radio waves at the point J and the point G are aligned and beamforming can be performed. The path difference L is calculated as follows.

$$[ Mathematical 9 ]$$

$$L = \vert {d}_{1} sin θ + ( cos θ — 1 ) \frac{2 {X}_{1} {d}_{1} + {d}_{1}^{2}}{4 P} \vert \qquad ( 12 )$$

The calculation of the path difference L described above will be described below. Each of equations of the lines l₁ and l₂ indicated above are respectively represented as follows.

$$[ Mathematical 10 ]$$

$${l}_{1} : g ( x ) = \frac{1}{tan θ} ( x - {X}_{1} ) + f ( {X}_{1} ) \qquad ( 13 )$$

$$[ Mathematical 11 ]$$

$${l}_{2} : h ( x ) = \frac{1}{tan θ} ( x - {X}_{2} ) + f ( {X}_{2} ) \qquad ( 14 )$$

Then, from (11), (13) and (14), the coordinates of the points F and G are respectively represented as follows.

$$[ Mathematical 12 ]$$

$$Point F : \underbrace{( {X}_{1} + ( P - f ( {X}_{1} ) ) sin θ}_{{X}_{F}} , \underbrace{g ( {X}_{1} + ( P - f ( {X}_{1} ) ) sin θ}_{{Y}_{F}} \qquad ( 15 )$$

$$[ Mathematical 13 ]$$

$$Point G : \underbrace{( {X}_{2} + ( P - f ( {X}_{2} ) ) sin θ}_{{X}_{G}} , \underbrace{h ( {X}_{2} + ( P - f ( {X}_{2} ) ) sin θ}_{{Y}_{G}} \qquad ( 16 )$$

In addition, the line l₃ is represented as follows.

$$[ Mathematical 14 ]$$

$${l}_{3} : y = - tan θ ( x - {X}_{G} ) + {Y}_{G} \qquad ( 17 )$$

When (17) is modified, the following equation is derived.

$$[ Mathematical 15 ]$$

$${l}_{3} : x \cdot tan θ + y - {X}_{G} \cdot tan θ - {Y}_{G} = 0 \qquad ( 18 )$$

Herein, a, b, and c are each defined as follows.

$$[ Mathematical 16 ]$$

$$a = tan θ \qquad ( 19 )$$

$$[ Mathematical 17 ]$$

$$b = 1 \qquad ( 20 )$$

$$[ Mathematical 18 ]$$

$$c = - {X}_{G} \cdot tan θ - {Y}_{G} \qquad ( 21 )$$

At this time, the path difference L is represented as follows by using a formula of a distance between a point and a straight line.

$$[ Mathematical 19 ]$$

$$\begin{matrix}L = \frac{\vert {aX}_{F} + {bY}_{F} + c \vert}{\sqrt{{a}^{2} + {b}^{2}}} \\ = \frac{\vert ( {X}_{F} - {X}_{G} ) \cdot tan θ + {Y}_{F} - {Y}_{G} \vert}{\sqrt{\frac{1}{{cos}^{2} θ}}}\end{matrix} \qquad ( 22 )$$

Herein, X_{F}-X_{G} is represented as follows by using (12) and (13).

$$[ Mathematical 20 ]$$

$${X}_{F} - {X}_{G} = ( {X}_{1} - {X}_{2} ) - ( f ( {X}_{1} ) - f ( {X}_{2} ) ) sin θ \qquad ( 23 )$$

In addition, from (13) and (14), the following equation is acquired.

$$[ Mathematical 21 ]$$

$$g ( {X}_{1} + ( P - f ( {X}_{1} ) ) sin θ = \frac{sin θ}{tan θ} ( P - f ( {X}_{1} ) ) + f ( {X}_{1} ) \qquad ( 24 )$$

$$[ Mathematical 22 ]$$

$$h ( {X}_{2} + ( P - f ( {X}_{2} ) ) sin θ = \frac{sin θ}{tan θ} ( P - f ( {X}_{2} ) ) + f ( {X}_{2} ) \qquad ( 25 )$$

From this, Y_{F}-Y_{G} is represented as follows by using (15) and (16).

$$[ Mathematical 23 ]$$

$${Y}_{F} - {Y}_{G} = ( 1 - \frac{sin θ}{tan θ} ) ( f ( {X}_{1} ) - f ( {X}_{2} ) ) \qquad ( 26 )$$

By substituting (23) and (26) into (22), the path difference L is as follows.

$$[ Mathematical 24 ]$$

$$L = \vert sin θ ( {X}_{1} - {X}_{2} ) + ( cos θ - 1 ) ( f ( {X}_{1} ) - f ( {X}_{2} ) ) \vert \qquad ( 27 )$$

By substituting (11) into (27) and further substituting a relation of X₂=X₁+d₁, (12) is acquired.

### [Description of Advantageous Effect]

In the third example embodiment, an example in which a point of emitting a radio wave in the antenna 22 is located at a point being plane-symmetric with a focal point of a parabola applied to a paraboloid of the RIS curved surface unit 32 with respect to a flat surface constituted by the reflector 31 has been described. Then, as indicated in (12), the path difference L depends on the reflection angle θ, the distance d₁, a position of the point R₁, and the focal point P, but, unlike the cases indicated in (8) to (10), it does not depend on a parameter indicating the path difference at an incidence stage. Therefore, the transmission apparatus 30 does not need to consider the path difference at the incidence stage in calculation of the phase control amount in each of the reflecting elements, and thereby the calculation can be simplified.

The control apparatus that performs the control of the phase control amount of each of the reflecting elements described above may be achieved by causing a processor in a computer to execute a computer program.

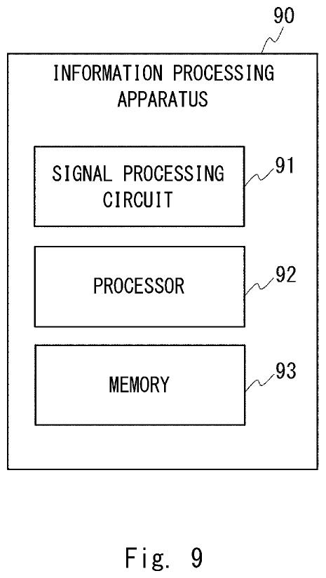

FIG. 9 is a block diagram illustrating a hardware configuration example of an information processing apparatus constituting the control apparatus in which processing of the present disclosure described above is executed. Referring to FIG. 9, the information processing apparatus 90 includes a signal processing circuit 91, a processor 92, and a memory 93.

The signal processing circuit 91 is a circuit for processing a signal according to control of the processor 92. Note that, the signal processing circuit 91 may include a communication circuit that receives a signal from the transmission apparatus.

The processor 92 is connected to the memory 93, and performs processing of the control apparatus described in the present disclosure by reading and executing a program from the memory 93. Examples of the processor 92 include a central processing unit (CPU), a micro processing unit (MPU), a field-programmable gate array (FPGA), a demand-side platform (DSP), and an application specific integrated circuit (ASIC). One processor may be used as the processor 92, or a plurality of processors may be used in cooperation.

The memory 93 is constituted by a volatile memory, a non-volatile memory, or a combination thereof. Note that, the volatile memory may be, for example, a random access memory (RAM) such as a dynamic random access memory (DRAM) or a static random access memory (SRAM). The non-volatile memory may be, for example, a read only memory (ROM) such as a programmable read only memory (PROM) or an erasable programmable read only memory (EPROM), a flash memory, or a solid state drive (SSD). One memory may be used as the memory 93, or a plurality of memories may be used in cooperation.

The memory 93 is used to store one or more instructions. Herein, one or more instructions are stored in the memory 93 as a program. The processor 92 can perform the processing described in the present disclosure by reading and executing the program from the memory 93.

Note that, the memory 93 may include a memory built in the processor 92, in addition to a memory provided outside the processor 92. In addition, the memory 93 may include a storage disposed away from a processor constituting the processor 92. In this case, the processor 92 can access the memory 93 via an input/output (I/O) interface.

As described above, one or a plurality of processors included in each apparatus of the present disclosure execute one or a plurality of programs including an instruction group for causing a computer to perform algorithm described with reference to the drawings. By the processing, information processing described in the present disclosure can be achieved.

The program includes an instruction group or a software code that, when loaded into a computer, cause the computer to perform one or more of functions described in the present disclosure. The program may be stored in a non-transitory computer readable medium or a tangible storage medium. By way of example, and not limitation, computer readable media or tangible storage media can include a random-access memory (RAM), a read-only memory (ROM), a flash memory, a solid-state drive (SSD) or other memory technologies, compact disk-read only memory (CD-ROM), compact disk-read/write (CD-R/W), digital versatile disk (DVD), Blu-ray disc ((R): Registered trademark) or other optical disk storage, magnetic cassettes, magnetic tape, magnetic disk storage or other magnetic storage devices. The program may be transmitted on a transitory computer readable medium or a communication medium. By way of example, and not limitation, transitory computer readable media or communication media can include electrical, optical, acoustical, or other form of propagated signals.

The first, second and third example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A transmission apparatus comprising:
an antenna configured to emit a radio wave to space;
a reflector configured to reflect a radio wave emitted from the antenna; and
a reconfigurable intelligent surface (RIS) reflecting plate configured to reflect a radio wave from the reflector and thereby transmit the reflected radio wave to a transmission target.

2. The transmission apparatus according to claim 1, wherein the antenna is provided on a back side of a reflecting surface on which the RIS reflecting plate reflects the radio wave when viewed from a direction in which the radio wave is incident on the RIS reflecting plate from the reflector.

3. The transmission apparatus according to claim 1, further comprising an amplifier configured to supply an amplified radio wave to the antenna,
wherein the amplifier is provided on a back side of a reflecting surface on which the RIS reflecting plate reflects the radio wave when viewed from a direction in which the radio wave is incident on the RIS reflection plate from the reflector.

4. The transmission apparatus according to claim 1, wherein a reflecting surface of the reflector that reflects the radio wave forms a paraboloid.

5. The transmission apparatus according to claim 1, wherein
a reflecting surface of the RIS reflecting plate that reflects the radio wave forms a paraboloid, and
a point at which the radio wave is emitted in the antenna is located at a point being plane-symmetric with a focal point of a parabola applied to the paraboloid with respect to a flat surface constituted of the reflector.

6. A manufacturing method of a transmission apparatus, comprising manufacturing a transmission apparatus by:
providing an antenna configured to emit a radio wave in space;
providing a reflector configured to reflect a radio wave emitted from the antenna; and
providing a reconfigurable intelligent surface (RIS) reflecting plate configured to reflect a radio wave from the reflector and thereby transmit the reflected radio wave to a transmission target.
